(19) United States
(12) Patent Application Publication
(10) Pub. No.: US 2023/0314295 A1
(43) Pub. Date: Oct. 5, 2023

(54) HIGH-SPEED SHEAR TESTING CORRELATED TO TENSILE STRENGTH FOR ADDITIVELY MANUFACTURED METALS USING MACHINE LEARNING

(71) Applicant: The Johns Hopkins University, Baltimore, MD (US)

(72) Inventors: Steven M. Storck, Catonsville, MD (US); Salahudin M. Nimer, Fulton, MD (US); Matthew T. Shanaman, Ephrata, PA (US); Andrew M. Lennon, Ellicott City, MD (US); Robert K. Mueller, Columbia, MD (US)

(21) Appl. No.: 18/104,670

(22) Filed: Feb. 1, 2023

Related U.S. Application Data
(60) Provisional application No. 63/326,496, filed on Apr. 1, 2022.

(51) Int. Cl. G01N 3/24; B22F 10/28; B22F 12/45; B22F 5/00; G01N 3/08

(52) U.S. Cl. CPC G01N 3/24; B22F 10/28; B22F 12/45; B22F 5/00; G01N 3/08; B22F 2005/005; G01N 2203/0025; G01N 2203/0017; G01N 2203/0075

(57) ABSTRACT

A process for estimating tensile properties associated with a metal additive manufactured component is disclosed. The process includes building ductile metal specimen samples layer-by-layer on a build plate by additive manufacturing, wherein each of the metal specimen samples includes at least one support member and a bridging member spanning a space defined by the at last one support member, wherein the bridging member includes an upper portion that is raised relative to top planar surfaces of the at least one support member, and a lower portion integrally bridging the space defined by the at least one support member and raised relative to the build plate. The process includes sequentially shear testing each of the plurality of specimen samples on the build plate by applying a load to the upper portion of the bridging member and measuring load, displacement and/or local strain values. The process also includes estimating tensile properties by extrapolating the load, displacement and/or local strain values obtained from the shear testing based on a plastic yield surface criterion.

### CROSS REFERENCE TO RELATED APPLICATIONS

This application claims the benefit of U.S. Provisional Patent Application No. 63/326,496, filed on Apr. 1, 2022, which is incorporated by reference herein in its entirety.

### STATEMENT REGARDING FEDERALLY SPONSORED RESEARCH OR DEVELOPMENT

This invention was made with Government support under Contract No. N00024-13-D-6400 awarded by the United States Department of the Navy. The Government has certain rights in the invention

### BACKGROUND OF THE INVENTION

The present disclosure generally relates to additive manufacturing (AM) processes to form three-dimensional metal articles. More particularly, the present disclosure relates to high-speed shear testing for additively manufactured metal specimen samples that is correlated to tensile response using machine learning.

AM processes generally include a sequential layer by layer build-up of a three-dimensional object of any shape from a design. In a typical AM process, a two-dimensional image of a first layer of material such as a metal, ceramic, and/or polymeric material is formed, and subsequent layers are then added one by one until such time a three-dimensional article is formed. Typically, the three-dimensional article is fabricated using a computer aided design (CAD) model. A particular type of AM process uses an energy beam, for example, an electron beam or electromagnetic radiation such as a laser beam, to thermally create each layer of the article in which particles of the powder material are bonded together and, where indicated, bonded to the underlying layer.

In AM processing of metals, a typical feedstock is a powdered metal or wire composition of one or more metals, which is sintered or fully melted by the energy input of a laser or electron beam. As a result, the powdered metal composition is transformed layer by layer into a solid three-dimensional part of nearly any geometry. The most popular AM processes for metals include laser beam melting, electron beam melting, and laser beam deposition. During AM processing, the metal powder or wire is subjected to a complex thermal cycle that includes rapid heating above the melting temperature of the respective metal due to energy absorption from the laser (or electron beam) and its subsequent transformation into heat to form a molten metal followed by rapid solidification after the heat source has moved on. Complex physics of the melt solidification combine with millions of parameters of options makes it nearly impossible to predict properties without rapid screening techniques. The AM process further includes numerous re-heating and re-cooling steps when subsequent layers are added to the evolving three-dimensional structure, which further adds to the complexity of the process.

Mechanical testing of additive manufactured metals plays an important role in understanding the complex relationships between basic process parameters, defects, and the final product of the AM process. Mechanical testing such as tensile testing, fatigue testing, torsion testing, hardness and impact tests, and the like, are crucial to determine various performance parameters of the intended component for the product. Regarding tensile strength, which is a measure of the maximum force or stress that a material is capable of sustaining, testing is most often performed per ASTM standards. In the tensile testing of three-dimensional printed materials, force, displacement and strain are measured and the corresponding stress-strain characteristics are plotted. Generally, properties like ultimate tensile strength, elongation, and elastic modulus are determined to understand the mechanical behavior under loading conditions.

ASTM E8 and ASTM A370 are the most common test standards for determining the tensile properties of metallic materials, which can be used to measure yield strength, yield point elongation, tensile strength, and reduction of area, among other properties. Although these tests allow for different specimen types and defines suitable geometries and dimensions for each one, the tests nevertheless require independent manufacture of the particular specimen type and also requires the operator to handle the test coupon for placement and operation of the appropriate tensile testing machine. For example, one of the more common specimen types can be characterized as being a dogbone-shaped rectangle with a width of 6 millimeters (mm) and a gauge length of 25 mm. Once the specimen type is additively manufactured to the particular dimension, the specimen is then independently placed by an operator within the tensile testing machine so that tensile properties can be measured. As such, the ASTM standards for tensile testing require fabrication of a specific specimen type having a particular geometry and dimensions that are independent from the build plate (i.e., physically removed from the build plate) so that the specimens can be hand-carried by the operator and tested in the tensile testing machine. One of the problems associated with tensile testing in this manner is the time required to independently fabricate the specimen type and the operator time required to use the tensile testing equipment. Moreover, each test coupon must be independently inserted into the testing machine, which is relatively inefficient. Additionally, the fabrication of tension samples take up significant amounts of space, which is highly limited, and uses large volumes of often very expensive powder.

### SUMMARY OF THE INVENTION

Disclosed herein are processes for estimating tensile properties associated with a metal additive manufactured component, processes for optimizing a parameter set for metal additive manufacturing, and additively manufactured metal specimen samples for estimating the tensile properties and optimizing the parameter set.

In one or more embodiments, the process for estimating tensile properties associated with a metal additive manufactured component includes building ductile metal specimen samples layer-by-layer on a build plate by additive manufacturing, wherein each of the metal specimen samples includes at least one support member and a bridging member spanning a space defined by the at last one support member, wherein the bridging member includes an upper portion that is raised relative to top planar surfaces of the at least one support member, and a lower portion integrally bridging the space defined by the at least one support member and raised relative to the build plate; sequentially shear testing each of the plurality of specimen samples on the build plate by applying a load to the upper portion of the bridging member and measuring load, displacement and/or local strain values; and estimating tensile properties by extrapolating the load, displacement and/or local strain values obtained from the shear testing based on a plastic yield surface criterion.

In accordance with one or more embodiments, the additively manufactured metal specimen sample for shear testing on a build plate configured for metal additive manufacturing of parts includes a first support member having a polygon cross-sectional shape defined by four perpendicularly oriented vertical sidewalls extending from a planar surface of the build plate, wherein the first support member includes a top planar surface; a second support member having a polygon cross-sectional shape defined by four perpendicularly oriented vertical sidewalls extending from the planar surface of the build plate and spaced apart from the first support member by a space, wherein the second support member includes a top planar surface coplanar to the top planar surface of the first support member; and a bridging member including a lower portion spanning between opposing vertical walls of the first and second support members and an upper portion having a top planar surface raised relative to the coplanar surfaces of the first and second support members, wherein shear regions are defined at interfaces between the lower portion of the bridging member and the first and second support members.

In accordance with one or more embodiments, the high-speed process for optimizing a parameter set for metal additive manufacturing includes designing a first multi-factorial parameter space encompassing a selected energy density; building multiple additively manufactured metal specimen samples configured for shear testing and x-ray computed tomography to inspect density on a first build plate for each parameter set within the multifactorial parameter space, wherein each parameter set comprises thickness, hatch spacing, power, scan velocity, exposure time, an energy density other than the selected energy density, or combinations thereof; building additional additively manufactured metal specimen samples on the first build plate for engineered parameter sets about the multifactorial parameter space; shear testing each of the additively manufactured specimen samples while attached to the first build plate by applying a load and measuring load, displacement and/or local strain values; estimating tensile properties by extrapolating the load, displacement and/or local strain values obtained from the shear testing based on a plasticity yield surface criterion; applying machine learning by developing a neural network to design a machine learning space by modeling a relationship between each parameter set defined in the first multi-factorial parameter space and the corresponding load, displacement and/or local strain values; and building and shear testing additional additively manufactured metal specimen samples on a second build plate based on the machine learning space.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

Example embodiments of the invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 graphically illustrates percent porosity as a function of energy density in accordance with classical energy density theory including boundaries defined by lack of fusion and keyhole defects;

FIG. 2 illustrates an exemplary prior art additive manufacturing system suitable for fabricating the additively manufactured metal specimen samples in accordance with one or more embodiments of the present disclosure;

FIGS. 3A, 3B and 3C illustrate elevational views and a bottom perspective view, respectively, of an additively manufactured metal specimen sample in accordance with one or more embodiments of the present disclosure;

FIG. 4 pictorially illustrates rows and columns of additively manufactured specimen samples fabricated and shear tested with a load cell on a build plate in accordance with one or more embodiments of the present disclosure;

FIGS. 5A and 5B pictorially illustrates shear testing of an additively manufactured specimen sample and the corresponding contour plot of maximum shear stress experienced during the shear test, respectively, in accordance with one or more embodiments of the present disclosure;

FIG. 6 graphically illustrates tensile properties as a function of shear performance in accordance with one or more embodiments of the present disclosure;

FIG. 7 graphically illustrates porosity, peak load and yield strength as a function of energy density including tensile response behavior relative to the predicted tensile response obtained by shear testing in accordance with one or more embodiments of the present disclosure; and

FIG. 8 graphically illustrates an exemplary expansion of a statistically defined parameter space subsequent to machine learning in accordance with one or more embodiments of the present disclosure.

### DETAILED DESCRIPTION

The present disclosure is generally directed to metal additive manufacturing (AM) processes and additively manufactured metal specimen samples that permit rapid and low-cost screening of mechanical properties. More particularly, the present disclosure is directed to high-speed shear testing of the additively manufactured metal specimen samples that are fabricated and shear tested while on a build plate, wherein the shear properties are then correlated to a tensile response based on a plastic yield surface criterion such as von Mises distortion energy criterion or the Tresca maximum shear stress criterion, for example, which have empirically been shown to relate yield stress in complex states of stress to uniaxial tensile yield stress in ductile materials.

Ductile materials are generally those that undergo significant plastic deformation before fracture. Most ductile additive manufactured metal parts fail due to shear stress unlike brittle materials that fail by breaking bonds between atoms due to normal stress. Because of this, estimation of tensile properties can be extrapolated from the shear testing properties based on a plastic yield surface criterion. In the present disclosure, unlike tensile measurements of test coupons that are tested independently from the build plate (i.e., physically removed from the build plate) as is done in the prior art, the additively manufactured metal specimen samples are fabricated and shear tested while attached to the build plate, which expedites the mechanical information that is obtained at a significantly lower cost compared to the prior art processes that require physical separation of the test specimens from the build plate. The mechanical information related to shear can then be correlated to tensile properties using the plastic yield surface criterion, which can be further optimized using a combination of statistical designs of experiment and machine learning. Application of machine learning is typically limited because of the cost associated with collecting the data. The rapid shear testing process in accordance with the present disclosure minimizes those costs, making machine learning a viable mechanism for further optimization of the statistically defined parameter space, thereby improving accuracy of the parameter space.

The additively manufactured metal specimen samples can be formed from the same metal compositions and additive manufacturing process parameters as the parts being manufactured on the build plate, which can be used to develop optimal parameter sets. The additively manufactured metal specimen samples can also be used as proof tests reducing the burden for subsequent qualification and eliminating destruction of the additively manufactured metal parts that would typically be used for qualification. Additionally, the additively manufactured metal specimen samples are generally configured for x-ray computed tomography to permit inspection of density.

The AM-alloy feedstock for additively manufacturing the specimen samples as well as AM parts on the build plate utilize metallic powder compositions, whose particle size may vary from the nanometer scale to micron scale. In one or more embodiments, the particle size ranges from about 10 μm to about 5000 μm. The metals defining the powder composition are not intended to be limited so long as the powder composition is capable of being melted, fused and/or sintered to form a two-dimensional image within a layer during AM processing. According to aspects of the present disclosure, the powder material can be any metallic material. Non-limiting examples of metallic materials include aluminum and its alloys, titanium and its alloys, nickel and its alloys, chromium-based alloys, stainless or chrome steels, copper alloys, cobalt-chrome alloys, tantalum, niobium, iron-based alloys, combinations thereof, and the like.

The specimen samples can be additively manufactured based on different energy beam parameters such as power, exposure time, point distance, scan velocity, hatch spacing (i.e., scan line spacing), and the like during the AM process, which can be optimized to yield a desired microstructure, defect distribution, and provide desired material properties for the AM metal parts. Initial optimization of the energy beam parameters for the additively manufactured metal specimen samples can be completed using a combination of statistical- and engineering-based sample methods. For example, a Latin hypercube experimental design can be used to project samples in power, speed, and hatch spacing. Engineering manipulation can be also used in parallel to test the energy density model with the ideal condition being the manufacturer specified bounds.

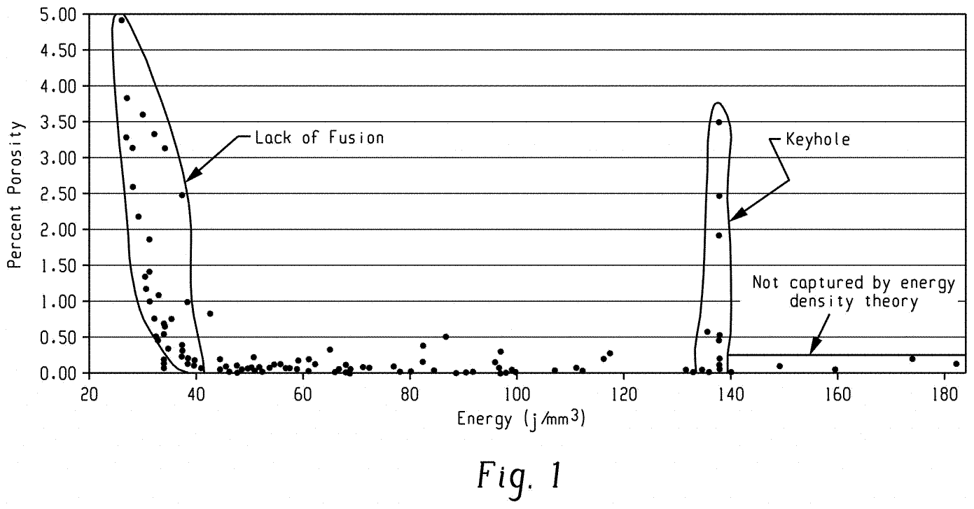

For example, as graphically shown in FIG. 1, the parameter process window for porosity optimization can be within the boundaries defined by lack of fusion defects and keyhole defects, which follows classical energy density theory limits. The ideal melt pool solidification is obtained between these defect boundaries to provide minimal porosity. Unfortunately, this classical energy density theory excludes parameters that provide an energy density outside of these boundaries, which unexpectedly do not necessarily result in increased porosity and can provide greater throughput, for example. Machine learning be used to extend and further optimize the processing window without regard to the constraints of the classical energy density theory. A neural network or regression analysis can be developed to predict porosity percentage and recommend optimal machine settings, which can be used to populate a second design of experiments exceeding the limits of the conventional processing space, i.e., a parameter space not captured by energy density theory.

Advantageously, the high-speed shear screening of the additively manufactured metal specimen samples offers a wider range of processing conditions for a given cost and timeline. Because the additively manufactured specimen samples are tested while on the build plate, the use of the additively manufactured metal specimen samples provide a significant reduction in testing time, operator involvement, and testing cost compared to standardized testing of testing coupons that require independent measurement away from the build plate such as the current practice for determining tensile properties of metallic AM materials. As such, the costs associated with machine learning by obtaining additional shear testing data based on a further optimized parameter space with the additively manufactured metal specimen samples is minimized. Without the rapid shear testing correlated to tensile properties provided by the additively manufactured metal specimen samples, machine learning to further optimize the parameter space is likely not economically feasible or efficient.

In the present disclosure, conventional techniques related to additive manufacturing processes for forming three-dimensional metal articles such as the additively manufactured metal specimen samples may or may not be described in detail herein. Moreover, the various tasks and process steps described herein can be incorporated into a more comprehensive procedure or process having additional steps or functionality not described in detail herein. Various steps in the additive manufacture of three-dimensional articles are well known and so, in the interest of brevity, many conventional steps will only be mentioned briefly herein or will be omitted entirely without providing the well-known process details.

For the purposes of the description hereinafter, the terms “upper”, “lower”, “top”, “bottom”, “left,” and “right,” and derivatives thereof shall relate to the described structures, as they are oriented in the drawing figures. The same numbers in the various figures can refer to the same structural component or part thereof. Additionally, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

Spatially relative terms, e.g., “beneath,” “below,” “lower,” “above,” “upper,” and the like, can be used herein for ease of description to describe one element or feature's relationship to another element(s) or feature(s) as illustrated in the figures.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like.

It will also be understood that when an element, such as a layer, region, or substrate is referred to as being “on” or “over” another element, it can be directly on the other element or intervening elements can also be present. In contrast, when an element is referred to as being “directly on” or “directly over” another element, there are no intervening elements present, and the element is in contact with another element.

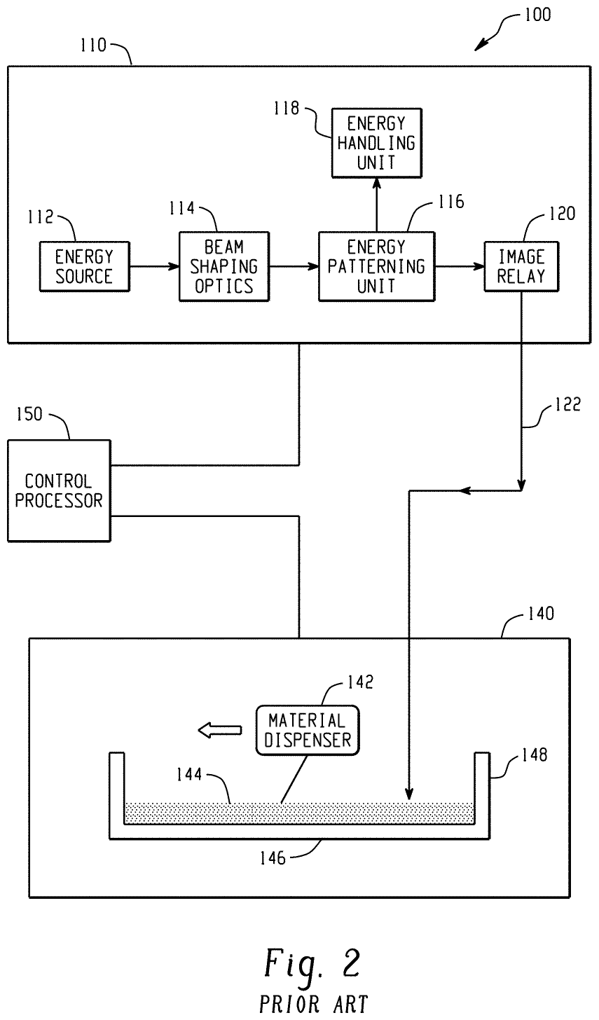

The AM process in accordance with the present disclosure is not intended to be limited and is generally a selective laser melting (SLM) process, also referred to as laser bed powder fusion or direct metal laser melting that uses a bed of the metal powder with a source of heat to create the three-dimensional metal parts layer by layer. FIG. 2 shows an exemplary additive manufacturing system 100 having an energy patterning system 110 with an energy source 112 that can direct one or more continuous or pulsed energy beam(s) toward beam shaping optics 114. After shaping, if necessary, the beam is patterned by an energy patterning unit 116, with generally some energy being directed to a rejected energy handling unit 118. Patterned energy is relayed by image relay 120 toward an article processing unit 140, typically as a two-dimensional image 122 focused near a bed 146. The bed 146 (with optional walls 148) can form a chamber containing material 144, such as for example metal powder, dispensed by material dispenser 142. Patterned energy, directed by the image relay 120, can melt, fuse, sinter, amalgamate, change crystal structure, influence stress patterns, or otherwise chemically or physically modify the dispensed layer of metal powder 144 to form structures with desired properties.

Energy source 112 generates photon (light), electron, ion, or other suitable energy beams or fluxes capable of being directed, shaped, and patterned. Multiple energy sources can be used in combination. The energy source 112 can include lasers, electron beams, or ion beams. Energy patterning unit 116 can include static or dynamic energy patterning elements. For example, photon, electron, or ion beams can be blocked by masks with fixed or movable elements. Rejected energy handling unit 118 may be used to disperse, redirect, or utilize energy not patterned and passed through the energy pattern image relay 120. Image relay 120 receives a patterned image (typically two-dimensional) from the energy patterning unit 116 and guides it toward the article processing unit 140. Article processing unit 140 can include a walled chamber having walls 148 and bed 146, and a material dispenser 142 for distributing material. The material dispenser 142 can distribute, remove, mix, provide gradations or changes in material type or particle size, or adjust layer thickness of material. Control processor 150 can be connected and programmed to control any components of the additive manufacturing system 100. The control processor 150 is provided with an interface to allow input of manufacturing instructions. For example, the control processor 150 may control the operation of the energy source 112 such as its translatable position; energy beam characteristic(s), including their respective beam patterns, pulsing characteristics, positional relationships, power levels, power densities, exposure times, point distance, velocity, or any combination thereof.

In the various commercially available AM systems, the parameters defining the energy beam can vary widely. Generally, the power of these additive manufacturing systems can be adjusted from about 10 to about 5000 W and will generally depend on the type of laser, the scanning velocity (which defines the exposure time) can be adjusted from about 100 mm/s to about 10,000 mm/s, hatch spacing (i.e., distance between adjacent scan lines) can be adjusted from about 10 μm to about 5000 μm, the energy density can range from about 10 J/mm³ to 10,000 J/mm³, the point distance can be in a range of about 10 μm to about 5000 μm, and layer thickness can be adjusted from about 10 μm to about 5,000 μm.

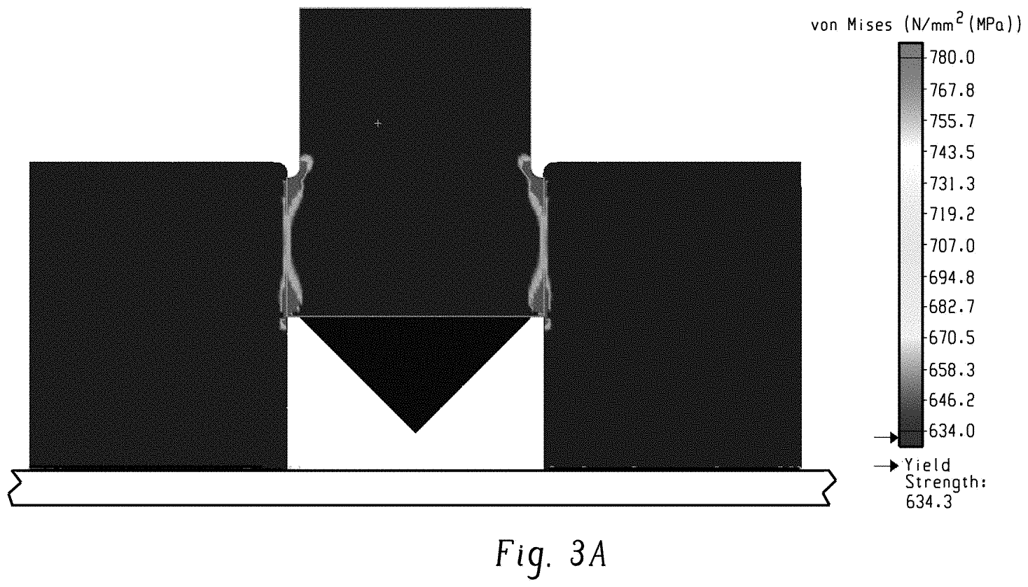

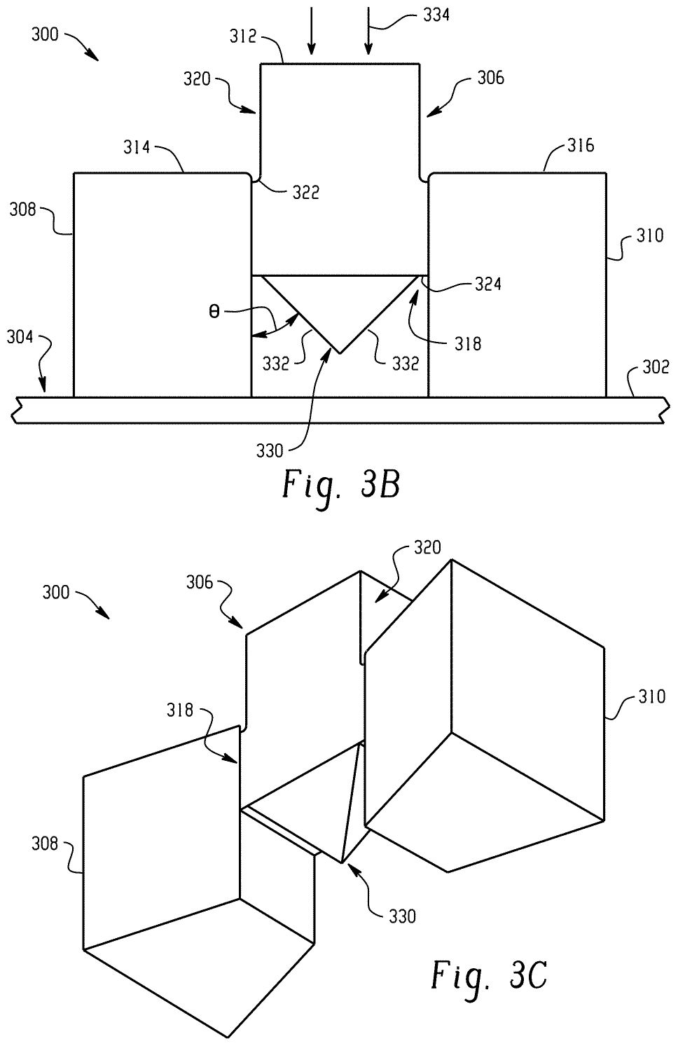

In FIGS. 3A-3C, there is depicted an additively manufactured metal specimen sample in accordance with the present disclosure generally designated by reference numeral 300. FIG. 3A depicts the additively manufactured specimen sample along with a contour plot of localized von Mises yield strength values as a function of applied load. FIG. 3B depicts the additively manufactured specimen sample formed on a planar surface 302 of a build plate 304 for an additive manufacturing system. The additively manufactured metal specimen sample 300 has a top hat geometry as shown that generally includes a load bearing bridge member 306 supported by at least one support members, fixtured to the build plate 304. In one embodiment, there are two spaced apart support members 308, 310, having a polygonal shape such as the trapezoidal shape as shown more clearly in FIG. 3C, wherein the load bearing bridge member 306 has a top planar surface 312 that is raised relative to top planar surfaces 314, 316 of the support members 308, 310, respectively. In the case of one support member (not shown), the support member is substantially cylindrically-shaped including a centrally located aperture extending to the build plate, wherein the bridging member is integrally positioned to cover a least a portion of the aperture and further includes a raised planar portion relative to the top plane surfaces of the support member as generally described above. For convenience in understanding the present disclosure, reference below will be made to the pair of spaced apart support members, wherein the bridging member spans the space between the pair of support members.

Each of the spaced apart support members 308, 310 is perpendicularly oriented with respect to the planar surface 302 of the build plate 304 and can have a width dimension of about 6 millimeters (mm) and a height dimension of about 9 mm. The support members have a polygonal shape defined by four vertical sidewalls perpendicularly oriented with respect to the build plate 304 and can be spaced apart from one another by a spacing of about 5 mm.

The load bearing bridge member 306 includes a lower portion 318 that spans between opposing vertical sidewalls of the support members 308, 310, and an upper portion 320 that is raised relative to the top planar surfaces 314, 316 of the support members 308, 310. In one or more embodiments, the lower portion 318 spans between the support members 308, 310 at about an upper half of the height dimension. The height dimension of the load bearing bridge member 306 from the lowermost point of integral attachment to the support members 308, 310 to its top planar surface 312 can be about 8 mm.

Optionally, a notch 322 of about 0.5 mm wide can be provided in the lower portion 318 at an interface between the top planar surface 314 or 316 of each respective leg 308, 310 and the respective vertical sidewall of the load bearing bridge member 306 as shown. Relative to the overall height dimension of the leg 308 or 310, the notch 322 can extend to a depth of less than about 5 percent of the overall leg height dimension. In one or more other embodiments, the notch 322 can extend for about to a depth of less than about 3 percent of the overall leg height dimension; and in still one or more other embodiments, the notch 322 can extend for about to a depth of less than about 2 percent of the overall leg height dimension. As will be discussed in greater detail below, the presence of the notch 322 minimizes boundary effects that can contribute to confounding displacement effects unrelated to shear, e.g., torsion, bending, and the like.

The lower portion 318 of the load bearing bridge member 306 can include a bottom planar surface (not shown) coplanar to its top planar surface 312 and the top planar surfaces 314, 316 of support members 308, 310. Alternatively, the lower portion 318 can include a downwardly projecting pyramidal-shape 330 as clearly shown in FIG. 3C or a downwardly projecting truncated pyramidal-shape (not shown) to minimize rotation due to changes in structural stiffness and non-linear plasticity, wherein the surfaces 332 defining the particular pyramidal-shape have the same length and are at about the same angle Θ relative to the perpendicularly originated support members 308, 310. In one or more embodiments shown in FIG. 3B, the downwardly projecting pyramidal-shaped surfaces 332 (or downwardly projecting truncated pyramidal-shaped surfaces) are at an angle Θ between 0 and about 135 to degrees relative to the inner vertical sidewall of a respective support member 308 or 310 from which it extends. In one or more other embodiments, the angle Θ between about 20 and about 60 degrees, and in still one or more other embodiments, the angle Θ between about 40 to 50 degrees.

In one or more embodiments, the lower portion 318 including the downwardly projecting pyramidal-shaped surfaces 332 (or downwardly projecting truncated pyramidal-shaped surfaces) is spaced apart from the support member 308, 310 such that a planar surface 324 is provided there between the vertical wall and the angled surface defining the pyramidal shaped surfaces. The length of the planar surface before transitioning to the angled surface defining the pyramidal-shaped surface is about the same as the width dimension of notch 322.

During shear testing, the top planar surface 312 of the additively manufactured specimen sample as indicated by arrows 334 is contacted with an appropriate load cell (not shown), i.e., force transducer, for measuring the amount of load (displacement) acting on the sample, which can then be correlated to one or more tensile-related properties using plastic yield surface criterion. In the shear test, the compressive force is incrementally increased and applied to the compressive shear specimen sample until failure. The applied load and displacement during shear the test can then be correlated to tensile strength. The relationship between shear strength and tensile strength can be characterized by the plastic yield surface criterion, e.g., Von Mises and/or Tresca criterions, which are commonly applied to ductile metals. By way of example, a contour plot of the von Mises stress values can be provided as shown in FIG. 3A, which is a value used to determine if a given material will yield or fracture. It is mostly used for ductile materials, such as metals. The von Mises yield criterion states that if the von Mises stress of a material under load is equal or greater than the yield limit of the same material under simple tension then the material will yield.

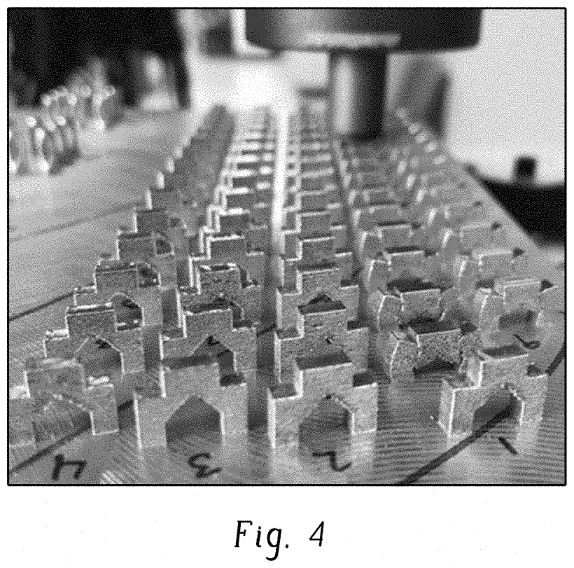

In FIG. 4, there is pictorially illustrated a build plate including a plurality of additively manufactured metal specimen samples formed thereon and arranged in rows and columns using additive manufacturing. Each additively manufactured metal specimen sample can be fabricated using the same parameters as may be desired when using the additively manufactured metal specimen samples as a proof for qualification or different parameters to provide an optimal parameter space as will be described in greater detail below to better understand the AM process and its effect of morphology. A load testing system, such as is commercially available from MTS, can be used to sequentially shear test each of the additively manufactured metal specimen samples and provide displacement information assuming comparable geometry. A controller can be programmed to guide the MTS load cell and/or the build plate such that shear stress for each sample can be measured and reported.

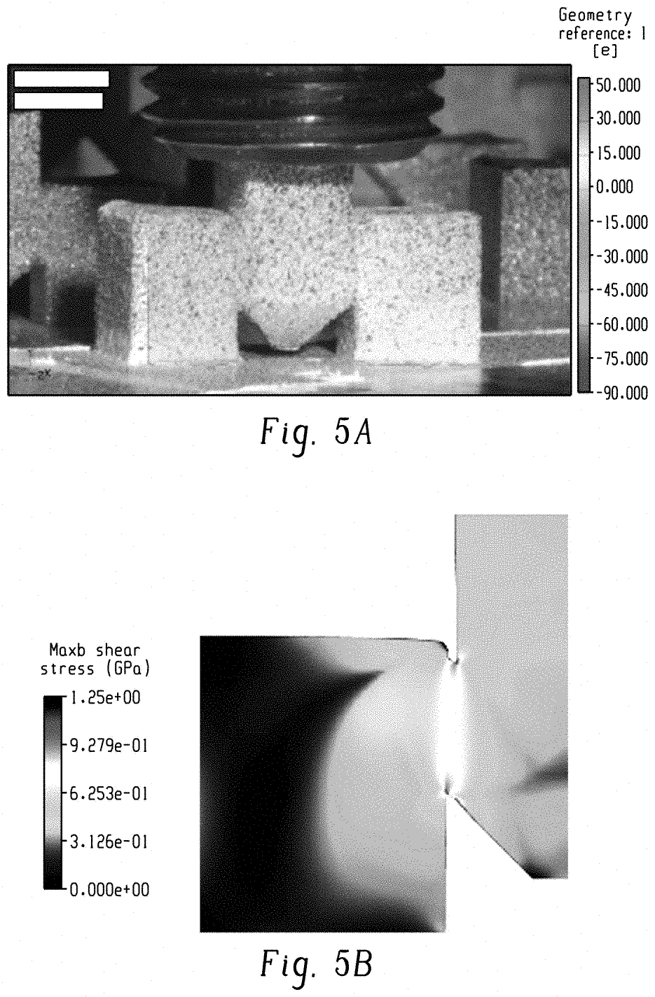

In FIGS. 5A and 5B, there are pictorially illustrated an additively manufactured metal specimen sample undergoing shear testing along with a contour plot illustrating maximum shear stress (GPa). As shown, shear stress is substantially isolated at about the interface between the lower portion of the bridging member and the opposing vertical walls of the support members that are fixtured to the build plate of the additively manufactured metal specimen sample.

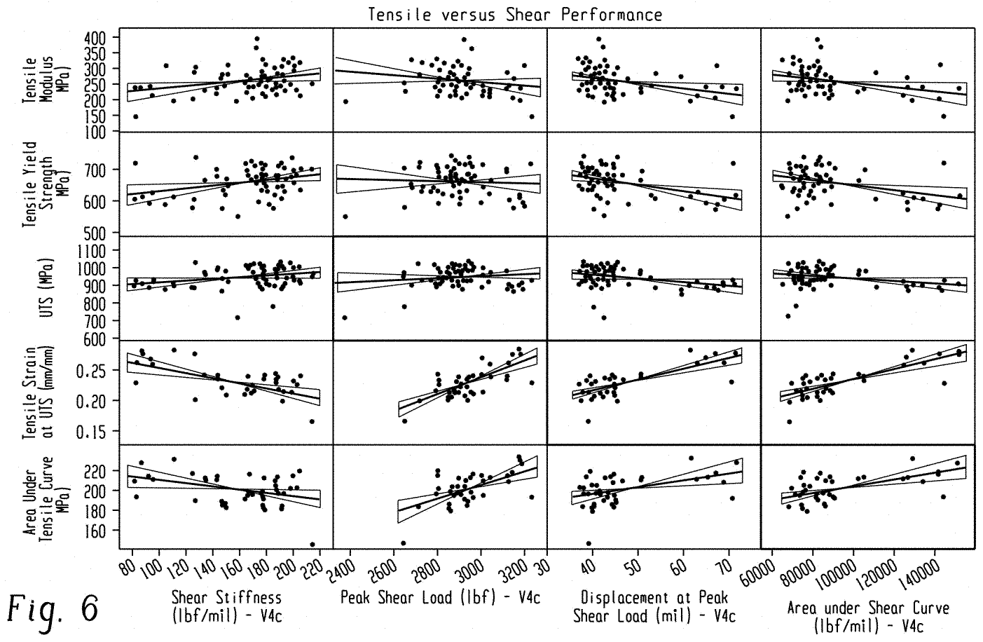

FIG. 6 graphically illustrates correlation between tensile performance and shear properties for different parameter sets. The highlighted boxes indicate property parallels between shear and tensile performance but a 1:1 correlation is not expected or needed for predictive capability.

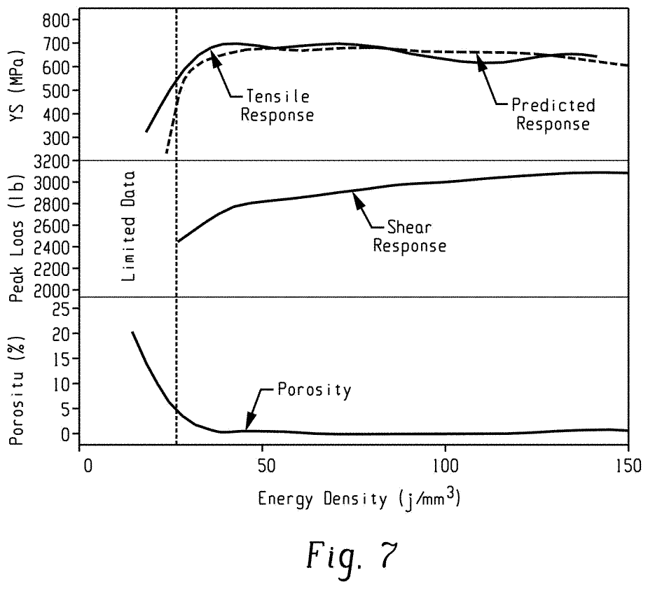

FIG. 7 graphically illustrates porosity percentage, peak load from shear testing and the predicted (correlated) and measured yield strength as a function of energy density for additively manufactured metal specimen samples. As shown, the correlated tensile response of yield strength closely tracked the actual yield strength.

As noted above, the additively manufactured metal specimen samples and the associated parameters for building the specimen samples are designed to be used in tandem with statistical methods and machine learning to predict the behavior of the additive manufacturing process, which permits the discovery of specimen samples exceeding the energy limits suggested by classical processing theory as noted above with respect to FIG. 1. Machine learning can be used to learn from the data that is readily collected from a statistical design of experiments and used to continually improve the accuracy of the processing space over time. Machine learning models, such as those based on neural networks or other regression techniques are generally known in the art, can be trained and fine-tuned on the data collected as additional areas of the processing space are explored by fabricating and rapidly characterizing new specimen samples in accordance with the machine learning. In this manner, machine learning techniques can be used to optimize future parameter selection by modeling the relationship between input processing parameters and outputs of material characterization. Such models can make predictions for points not covered by the initial statistical design of experiments.

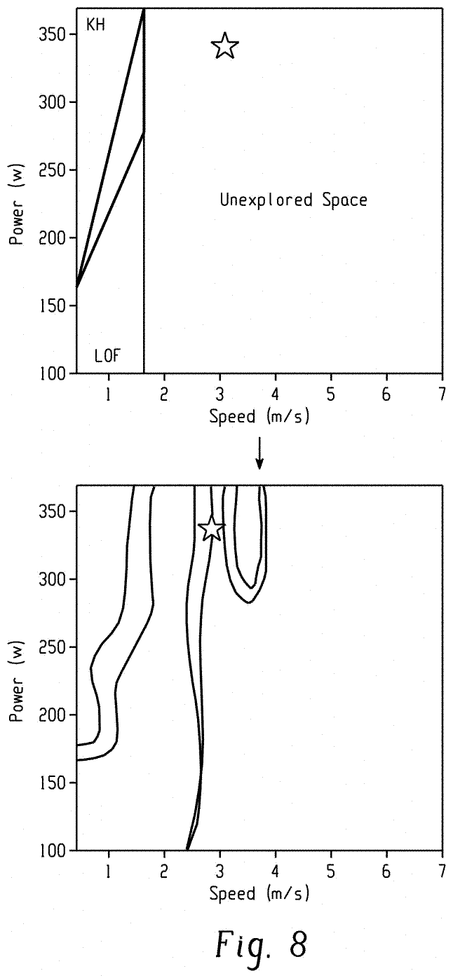

FIG. 8 graphically illustrates an exemplary expansion of the parameter space subsequent to machine learning relative to a conventional processing space obtained after an initial statistical and engineering optimization utilizing the shear testing as described above to estimate tensile properties. A neural network was developed to predict porosity and recommended optimal machine settings. This was used populate a second design of experiments exceeding the limits of the conventional processing space. As shown in the upper graph, the boundaries of a statistically optimized parameter space about a selected energy density are generally limited by areas defined by lack of fusion (LOF) defects and keyhole (KH) defects. Application of machine learning has been found to expand upon this conventional space to provide new areas of processing space. For example, as shown in the lower graph, the processing space subsequent to application of machine learning unexpectedly resulted in a new area of processing space that was robust and provided about 3 times faster print speed than that obtained by the initial statistically optimized processing space while demonstrating minimal porosity and high strength based on the estimated tensile properties. An optimal parameter space is indicated by the start in the lower graph that would not have been realized if the parameter space was limited to the areas defined LOF defects and KH defects in the upper graph.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A process for estimating tensile properties associated with a metal additive manufactured component, the process comprising:
building ductile metal specimen samples layer-by-layer on a build plate by additive manufacturing, wherein each of the metal specimen samples comprises at least one support member and a bridging member spanning a space defined by the at last one support member, wherein the bridging member includes an upper portion that is raised relative to top planar surfaces of the at least one support member, and a lower portion integrally bridging the space defined by the at least one support member and raised relative to the build plate;
sequentially shear testing each of the plurality of specimen samples on the build plate by applying a load to the upper portion of the bridging member and measuring load, displacement and/or local strain values; and
estimating tensile properties by extrapolating the load, displacement and/or local strain values obtained from the shear testing based on a plastic yield surface criterion.

2. The process of claim 1, wherein the at least one support member comprises a pair of spaced apart perpendicularly oriented support members with each of the spaced apart support members defined by four vertical walls relative to the build plate.

3. The process of claim 1, wherein the at least one support member is cylindrically-shaped including a centrally located aperture defining the space.

4. The process of claim 1, wherein each of the additively manufactured specimen samples is built with a different parameter set and/or energy density.

5. The process of claim 1, wherein the lower portion of the bridging member comprises a pyramidal-shaped portion or a truncated pyramidal-shaped portion.

6. The process of claim 1, wherein interfaces between the bridging member and the top planar surface of the at least one support member are notched to a depth of less than 5 percent of a height dimension.

7. The process of claim 1, wherein the lower portion of the bridging member is equal to or less than about one half of a height dimension of the support member.

8. The process of claim 1, wherein the space is equal to or less than about one half of a width dimension of the at least one support member.

9. The process of claim 1, wherein the surface at the lower portion of the bridging member is at an angle within a range of 0 to about 135 degrees relative to the vertical wall of a respective one of the support members.

10. An additively manufactured metal specimen sample for shear testing on a build plate configured for metal additive manufacturing of parts, the additively manufactured metal specimen sample comprising:
a first support member having a polygon cross-sectional shape defined by four perpendicularly oriented vertical sidewalls extending from a planar surface of the build plate, wherein the first support member includes a top planar surface;
a second support member having a polygon cross-sectional shape defined by four perpendicularly oriented vertical sidewalls extending from the planar surface of the build plate and spaced apart from the first support member by a space, wherein the second support member includes a top planar surface coplanar to the top planar surface of the first support member; and
a bridging member including a lower portion spanning between opposing vertical walls of the first and second support members and an upper portion having a top planar surface raised relative to the coplanar surfaces of the first and second support members, wherein shear regions are defined at interfaces between the lower portion of the bridging member and the first and second support members.

11. The additively manufactured metal specimen sample of claim 10, wherein a surface of the lower portion of the bridging member comprises a pyramidal-shaped portion or a truncated pyramidal-shaped portion.

12. The additively manufactured metal specimen sample of claim 10, wherein interfaces between the bridging member and the top planar surfaces of the support members are each notched to a depth of less than 5 percent of a height dimensions of the support member.

13. The additively manufactured metal specimen sample of claim 10, wherein the lower portion of the bridging member is equal to or less than one half of a height dimension of the support member.

14. The additively manufactured metal specimen sample of claim 10, wherein the first and second support members have a width dimension about equal to the space therebetween.

15. The additively manufactured metal specimen sample of claim 10, wherein a surface of the lower portion of the bridging member is at angle within a range of 0 to about 135 degrees relative to a proximate one of the vertical walls of the support members.

16. A high-speed process for optimizing a parameter set for metal additive manufacturing, the process comprising:
designing a first multi-factorial parameter space encompassing a selected energy density;
building multiple additively manufactured metal specimen samples configured for shear testing and x-ray computed tomography to inspect density on a first build plate for each parameter set within the multifactorial parameter space, wherein each parameter set comprises thickness, hatch spacing, power, scan velocity, exposure time, an energy density other than the selected energy density, or combinations thereof, building additional additively manufactured metal specimen samples on the first build plate for engineered parameter sets about the multifactorial parameter space;
shear testing each of the additively manufactured specimen samples while attached to the first build plate by applying a load and measuring load, displacement and/or local strain values;
estimating tensile properties by extrapolating the load, displacement and/or local strain values obtained from the shear testing based on a plasticity yield surface criterion;
applying machine learning by developing a neural network to design a machine learning space by modeling a relationship between each parameter set defined in the first multi-factorial parameter space and the corresponding load, displacement and/or local strain values; and
building and shear testing additional additively manufactured metal specimen samples on a second build plate based on the machine learning space.

17. The process of claim 16, wherein the metal specimen sample comprises a first support member having a polygon cross-sectional shape defined by four perpendicularly oriented vertical sidewalls extending from a planar surface of the build plate, wherein the first support member includes a top planar surface; a second support member having a polygon cross-sectional shape defined by four perpendicularly oriented vertical sidewalls extending from the planar surface of the build plate and spaced apart from the first support member by a space, wherein the second support member includes a top planar surface coplanar to the top planar surface of the first support member; and a bridging member including a lower portion spanning between opposing vertical walls of the first and second support members and an upper portion having a top planar surface raised relative to the coplanar surfaces of the first and second support members.

18. The process of claim 16, wherein the machine learning space expands the first multifactorial parameter space to predict an optimal parameter set.

19. The process of claim 16, further comprising building additional additively manufactured metal specimen samples on the first build plate for engineered parameter sets about the multifactorial parameter space.

20. The process of claim 16, wherein a surface of the lower portion of the bridging member comprises a pyramidal-shaped portion or a truncated pyramidal-shaped portion.

21. The process of claim 16, wherein the lower portion of the bridging member is at angle within a range of 0 to about 135 degrees relative to a proximate one of the vertical walls of the support members.

22. The process of claim 16, wherein interfaces between the bridging member and the top planar surfaces of the support members are each notched to a depth of less than 5 percent of a height dimensions of the support member.
